(19) United States
(12) Patent Application Publication
(10) Pub. No.: US 2025/0354654 A1
(43) Pub. Date: Nov. 20, 2025

(54) PRESSURE VESSEL AND METHOD FOR MANUFACTURING THE SAME

(71) Applicants: Hyundai Motor Company, Seoul (KR); Kia Corporation, Seoul (KR)

(72) Inventor: Chan Jin Kim, Hwaseong-si (KR)

(21) Appl. No.: 18/889,820

(22) Filed: Sep. 19, 2024

(30) Foreign Application Priority Data
May 16, 2024 (KR) 10-2024-0064099

(51) Int. Cl. F17C 1/06

(52) U.S. Cl. CPC F17C 1/06; F17C 2201/0109; F17C 2203/0604

(57) ABSTRACT

An embodiment pressure vessel includes a liner and a composite material. The liner includes a cylinder part defining a central area of an outer surface of the liner and a dome part defining a peripheral area of the outer surface of the liner and connected to opposite ends of the cylinder part in a lengthwise direction, wherein when an imaginary straight line passing through a center of the liner and extending in the lengthwise direction is defined as a reference straight line. The composite material includes a plurality of bands surrounding the outer surface of the liner and a first composite material area having a shape surrounding the dome part and in which a plurality of band sets, only portions of which overlap each other, are stacked along the lengthwise direction, wherein the first composite material area is rotationally symmetrical with respect to the reference straight line.

### CROSS-REFERENCE TO RELATED APPLICATIONS

This application claims the benefit of Korean Patent Application No. 10-2024-0064099, filed on May 16, 2024, which application is hereby incorporated herein by reference.

### TECHNICAL FIELD

The present disclosure relates to a pressure vessel and a method for manufacturing the same.

### BACKGROUND

A pressure vessel that accommodates a high-pressure fluid is designed to withstand an internal pressure load by stacking reinforcing layers on a vessel through a scheme of applying a filament winding process. To efficiently design such a pressure vessel, a continuous fiber composite material that is an anisotropic material has to be arranged along various directions.

Then, the continuous fiber composite material is stacked through a polar winding or helical winding scheme to reinforce the dome part of the liner. In the case of winding for reinforcing the dome part in this way, an orientation angle of the composite material that surrounds a cylinder part is determined when a reinforcement point (pole) of the dome part is designated.

To simplify a mechanical model, conventional pressure vessels have been manufactured without considering seating positions of bands on the same layer or an influence between adjacent bands. In this way, in the conventional pressure vessel manufactured without considering the influence between adjacent bands, cracks are generated between adjacent bands or a portion of the band is folded due to an internal pressure load applied to the pressure vessel whereby permanent deformation occurs in the pressure vessel.

### SUMMARY

Embodiments of the present disclosure can solve problems occurring in the prior art while advantages achieved by the prior art are maintained intact.

An embodiment of the present disclosure provides a pressure vessel that prevents cracks from occurring between adjacent bands due to an internal pressure load, while considering an influence between adjacent bands.

An embodiment of the present invention also provides a pressure vessel that prevents permanent deformation in the pressure vessel due to folding of a portion of a band due to an internal pressure load.

The technical problems solvable by embodiments of the present disclosure are not limited to the aforementioned problems, and any other technical problems not mentioned herein will be clearly understood from the following description by those skilled in the art to which the present disclosure pertains.

According to an embodiment of the present disclosure, a pressure vessel includes a liner configured such that a pressure is applied to an inner surface thereof and a composite material including a plurality of bands surrounding an outer surface of the liner. The liner includes a cylinder part defining a central area of the outer surface of the liner and a dome part defining a peripheral area of the outer surface of the liner and connected to opposite ends of the cylinder part in a lengthwise direction, when an imaginary straight line passing through a center of the liner and extending in the lengthwise direction is defined as a reference straight line. The composite material includes a first composite material area having a shape surrounding the dome part, and in which a plurality of band sets, of which only portions of which overlap each other, are stacked along the lengthwise direction, and the first composite material area is rotationally symmetrical with respect to the reference straight line.

Furthermore, each of the plurality of band sets may have a shape surrounding a central portion of the dome part and being rotationally symmetrical with respect to the reference straight line.

Furthermore, the plurality of band sets may have similar shapes.

Furthermore, when a direction in which the plurality of band sets are stacked is defined as a stack direction, and when, among two arbitrary band sets of the plurality of band sets that are adjacent to each other in the stack direction, a band set located on a side in the stack direction is defined as a stacked band set, and among the two arbitrary band sets, a band set located on a side in an opposite direction to the stack direction is defined as a reference band set, the stacked band set may overlap the reference band set along the stack direction and may have a shape being rotated about the reference straight line and being rotated in a first circumferential direction of the cylinder part by a stack angle with respect to the reference band set.

Furthermore, the stack angle may be not less than 1 degree and not more than 30 degrees.

Furthermore, when among the plurality of bands, a band defining any partial area of the reference band set is defined as a reference band, and a band defining any partial area of the stacked band set and stacked on the reference band in the dome part is defined as a stacked band, an area of the reference band that surrounds the cylinder part and an area of the stacked band that surrounds the cylinder part may be arranged to contact each other on one side in a direction being perpendicular to a direction in which the reference band and the stacked band extend.

Furthermore, each of the plurality of band sets may include a cross area being an area in which, among the plurality of bands, two different arbitrary bands cross each other, and the cross area may be disposed on the dome part.

Furthermore, a size of an angle defined by, among the plurality of bands, two different arbitrary bands defining the cross area may be not less than 50 degrees and not more than 90 degrees.

Furthermore, an area in which, among two different arbitrary bands of the plurality of bands that define the cross area, any one band surrounds the cylinder part, and an area in which another band surrounds the cylinder part may be spaced apart from each other with the cylinder part being interposed therebetween.

Furthermore, a plurality of cross areas may be provided, and the plurality of cross areas may be rotationally symmetrical with respect to the reference straight line.

Furthermore, each of the plurality of band sets may further include a plurality of extension areas extending between, among the plurality of cross areas, two adjacent arbitrary cross areas, and alternately arranged with the plurality of cross areas along a circumferential direction of the cylinder part, and the plurality of extension areas may be defined by the plurality of different bands.

Furthermore, centers of, among the plurality of cross areas provided in the plurality of band sets, respectively, cross areas connected to contact each other along the lengthwise direction may be arranged on a spiral shape.

Furthermore, each of the plurality of bands may include a plurality of cylinder areas surrounding the cylinder part, and sizes of angles defined by the plurality of cylinder areas and the reference straight line may be the same.

Furthermore, the composite material may further include a second composite material area surrounding the cylinder part, and when a direction in which the plurality of band sets are stacked is defined as a stack direction, a thickness of the first composite material area in the stack direction may be greater than a thickness of the cylinder part of the second composite material area in a radial direction.

Furthermore, the thickness of the first composite material area in the stack direction is formed to be greater as it goes from an area in which the dome part and the cylinder part are connected to each other to a central portion of the dome part.

According to another embodiment of the present disclosure, a method for manufacturing a pressure vessel includes a preparation operation of preparing a liner configured such that a pressure is applied to an inner surface thereof and a winding operation of winding a band-type base material on an outer surface of the liner. The winding operation includes a reference band set forming operation of forming a reference band set in a dome part of the liner by winding the band-type base material on an outer surface of the liner, wherein a plurality of reference bands corresponding to any partial areas of the wound band-type base material are sequentially formed on the dome part along a circumferential direction of the cylinder part, and a stacked band set forming operation of forming a stacked band set in the dome part by winding the band-type base material on the reference band set, wherein a plurality of stacked bands corresponding to other partial areas of the wound band-type base material are sequentially formed in the dome part along the circumferential direction, and the stacked band set forming operation includes forming the plurality of stacked bands such that the plurality of stacked bands cross centers of the plurality of reference bands on the dome part to correspond to the plurality of reference bands, respectively.

Furthermore, when any one of the plurality of reference bands is defined as a first reference band, and when, among the plurality of stacked bands, a stacked band corresponding to the first reference band and formed to cross the first reference band is defined as a first stacked band, the stacked band set forming operation may include forming the stacked band set such that the first reference band and the first stacked band define a stack angle, the stacked band set forming operation may be repeatedly performed a plurality of times, when among the stacked band set forming operations performed the plurality of times, an arbitrary operation performed the plurality of times is defined as a first operation, and, among the stacked band set forming operations performed the plurality of times, an operation performed immediately after the first operation is performed is defined as a second operation, a second stacked band set formed in the second operation may be stacked on a first stacked band set formed in the first operation, and the second band set may have a shape overlapping the first stacked band set along a stack direction, and being rotated about a reference straight line in a first circumferential direction by the stack angle with respect to the first stacked band set.

### BRIEF DESCRIPTION OF THE DRAWINGS

The above and other objects, features, and advantages of embodiments of the present disclosure will be more apparent from the following detailed description taken in conjunction with the accompanying drawings, in which:

FIG. 1 is a perspective view of a pressure vessel according to an embodiment of the present disclosure;

FIG. 2 is a cross-sectional view illustrating a pressure vessel according to an embodiment of the present disclosure taken along a lengthwise direction thereof;

FIG. 3 is a view illustrating one side of a pressure vessel according to an embodiment of the present disclosure in a lengthwise direction thereof;

FIG. 4 is a view illustrating a plurality of band sets according to an embodiment of the present disclosure;

FIGS. 5A-5D are views sequentially illustrating states in which a plurality of band sets are stacked on a pressure vessel according to an embodiment of the present disclosure; and

FIG. 6 is a flowchart schematically illustrating a method for manufacturing a pressure vessel according to an embodiment of the present disclosure.

### DETAILED DESCRIPTION OF ILLUSTRATIVE EMBODIMENTS

Hereinafter, embodiments of the present disclosure will be described in detail with reference to the accompanying drawings. In adding reference numerals to the components of the drawings, it is noted that the same components are denoted by the same reference numerals even when they are drawn in different drawings. Furthermore, in describing the embodiments of the present disclosure, when it is determined that a detailed description of related known configurations and functions may hinder understanding of the embodiments of the present disclosure, a detailed description thereof will be omitted.

Hereinafter, a pressure vessel 10 according to an embodiment of the present disclosure will be described with reference to the drawings.

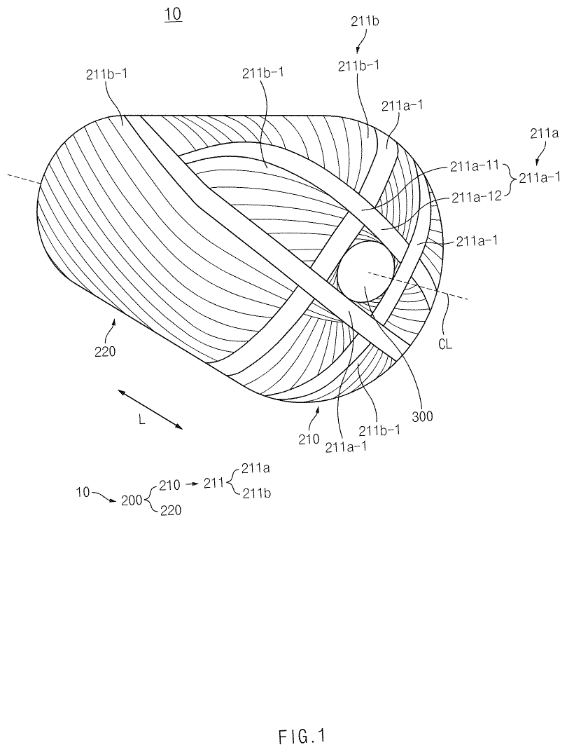

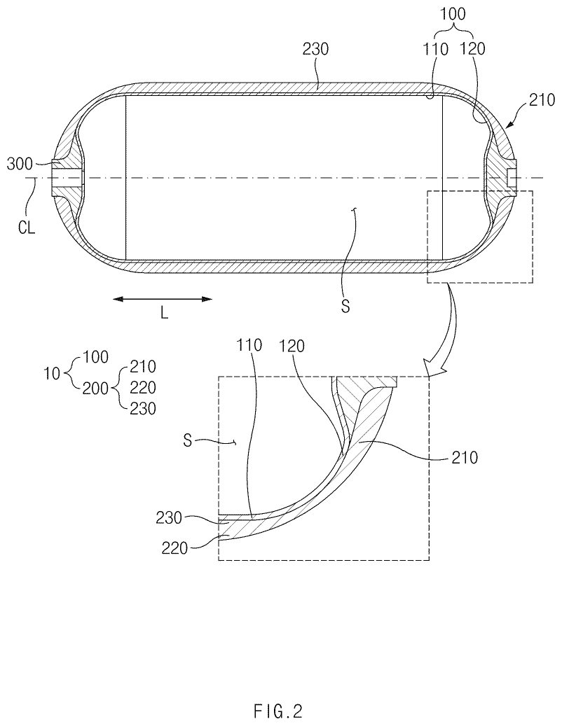

FIG. 1 is a perspective view of a pressure vessel according to an embodiment of the present disclosure, and FIG. 2 is a cross-sectional view illustrating the pressure vessel according to an embodiment of the present disclosure taken along a lengthwise direction thereof.

Referring to FIGS. 1 and 2, the pressure vessel 10 may be used in a means of transportation including a hydrogen fuel cell. A high-pressure fluid (e.g., a high-pressure hydrogen gas) may be accommodated in an interior of the pressure vessel 10. Furthermore, a fluid accommodated in the interior of pressure vessel 10 may be discharged to an outside of the pressure vessel 10. The pressure vessel 10 may include a liner 100, a composite material 200, and a nozzle 300.

An interior space “S” for accommodating the fluid may be formed in the liner 100. The interior space “S” may be surrounded by an inner surface of the liner 100. As an example, this liner 100 may be formed of plastic. The liner 100 may include a cylinder part 110 and a dome part 120.

The cylinder part 110 may define a central area of the liner 100. As an example, this cylinder part 110 may have a cylindrical shape.

The dome part 120 may define a peripheral area of the liner 100. As an example, this dome part 120 may have a hemispherical shape having a hole at a center thereof. A plurality of dome parts 120 may be provided. The plurality of dome parts 120 may be provided in two separate areas that are disposed to be spaced apart from each other in a lengthwise direction “L” with the cylinder part 110 being interposed therebetween. Each of the two dome parts 120 may be connected to opposite sides of the cylinder part 110 in the lengthwise direction “L.”

The lengthwise direction “L” may mean a direction that is parallel to a height direction of a cylinder of the cylinder part 110 having a cylindrical shape. Furthermore, circumferential directions C1 and C2 may mean the circumferential directions of the cylinder part 110 having the cylindrical shape. The circumferential directions may include a first circumferential direction C1 and a second circumferential direction C2. The first circumferential direction C1 and the second circumferential direction C2 may be opposite directions. For example, referring to FIG. 2, when one side of the pressure vessel 10 in the lengthwise direction “L” is viewed in parallel to a reference straight line CL, one of the first circumferential direction C1 and the second circumferential direction C2 may be clockwise, and the other may be counterclockwise. However, the embodiments of the present disclosure are not limited thereto, and the first circumferential direction C1 and the second circumferential direction C2 may be changed depending on a direction in which the pressure vessel 10 is viewed. As an example, the two dome parts 120 and the cylinder part 110 may be formed integrally.

A composite material 200 may be configured to surround an outer surface of the liner 100. The composite material 200 may include a plurality of bands. A band may be defined by a winding area that is defined by a continuous band-type base material. For example, one band may refer to a unit area of a winding area that surrounds the outer surface of the liner 100 once. In other words, the plurality of bands may be defined by a band-type base material having a continuous string shape.

For example, the band-type base material may have a material into which fibers, such as polymer, metal, or ceramic, are impregnated. As a detailed example, the band-type base material may include a plurality of fibers “F.” The plurality of fibers “F” may be arranged along a widthwise direction of the band-type base material. The widthwise direction of the band-type base material may mean a direction that is perpendicular to a direction in which the band-type base material extends. The composite material 200 may include a first composite material area 210, a second composite material area 220, and a third composite material area 230.

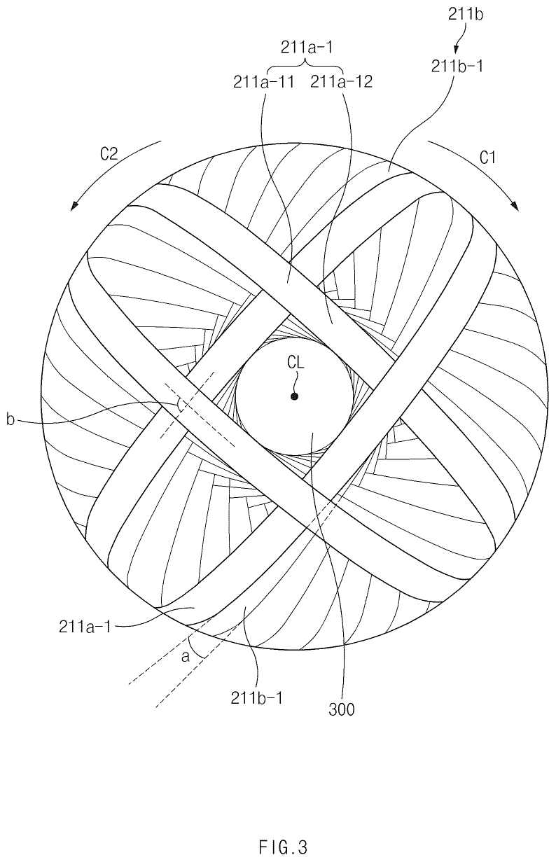

FIG. 3 is a view illustrating one side of a pressure vessel according to an embodiment of the present disclosure in a lengthwise direction thereof.

Referring further to FIG. 3, the first composite material area 210 may refer to an area of the composite material 200 that surrounds the dome part 120 of the liner 100. Two first composite material areas 210 may be provided and may be disposed in the two dome parts 120 provided on opposite sides of the liner 100 in the lengthwise direction “L,” respectively.

This first composite material area 210 may have a shape that is rotationally symmetrical with respect to the reference straight line CL. For example, the first composite material area 210 may have a shape that is rotationally symmetrical “n” (“n”>2) times. As a detailed example, when the first composite material area 210 is divided into “n” symmetric areas each having the same rotation angle of 360 degrees/n along the first circumferential direction C1, the “n” symmetric areas may have the same shape. The symmetric area may have a shape that is similar to a shape of an unfolded fan when one side of the pressure vessel 10 in the lengthwise direction “L” is viewed in parallel to the reference straight line CL.

As a more detailed example, each of the “n” symmetric areas may have the same size and shape in the circumferential directions C1 and C2 and the lengthwise direction “L.” As an example, this first composite material area 210 may have a shape that is rotationally symmetrical four times as illustrated in FIG. 3. However, embodiments of the present disclosure are not limited to the example, and the first composite material area 210 may have a shape that is rotationally symmetrical any one of times of natural numbers 3 and 5 or more.

The first composite material area 210 may have a shape in which a plurality of band sets 211 that only partially overlap each other are stacked. For example, a stacked band set 211a that is one of the plurality of band sets 211 may only partially overlap a reference band set 211b that is another one of the plurality of band sets 211 along the stack direction and may have a shape that is rotated about the reference straight line CL in the first circumferential direction C1 by stack angle “a”. The band set 211 may be defined by one angular shape including several bands. Furthermore, one rotationally symmetrical structure of several bands may be defined by a band set 211, and one unit that includes several band sets 211 so that the liner 100 is tightly filled may be named a ‘layer’ or ‘lamina.’

The stacked band set 211a may mean, among two arbitrary band sets of the plurality of band sets 211, a band set that is relatively located in the stack direction. The reference band set 211b may mean, among two arbitrary band sets of the plurality of band sets 211, a band set that is relatively located on an opposite direction to the stack direction. Furthermore, two band sets being adjacent to each other along the stack direction may mean that surfaces of the two band sets directly contact each other along the stack direction. As an example, a stack angle “a” may be not less than 1 degree and not more than 30 degrees. As a preferred example, the stack angle “a” may be not less than 1 degree and not more than 10 degrees.

Furthermore, the plurality of band sets 211 may have similar shapes. For example, when one side of the pressure vessel 10 in the lengthwise direction “L” is viewed in a direction that is parallel to the reference straight line CL, the plurality of band sets 211 may have corresponding shapes. It may be understood that the plurality of band sets 211 having corresponding shapes not only means that each of the plurality of band sets 211 has the same shape, but also that the plurality of band sets 211 have similar shapes similar to show the same function and effect as that of the same shape.

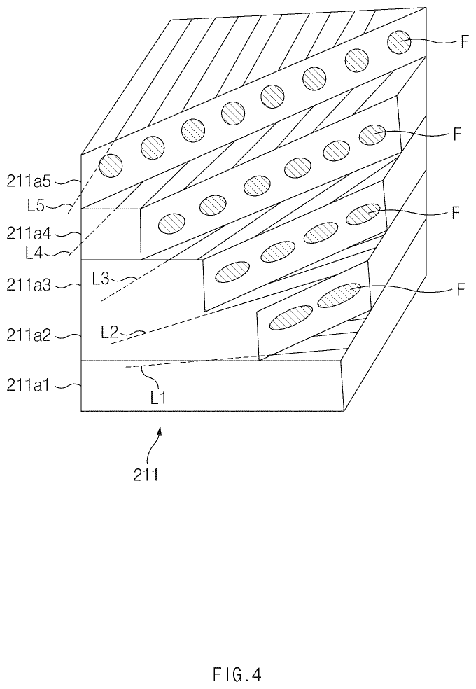

Hereinafter, a relationship between, among the plurality of band sets 211, any five band sets that are stacked to be sequentially connected to each other will be described with further reference to FIG. 4.

FIG. 4 is a view illustrating a plurality of band sets according to an embodiment of the present disclosure.

The plurality of band sets 211 may include a first band set 211a1, a second band set 211a2, a third band set 211a3, a fourth band set 211a4, and a fifth band set 211a5. The second band set 211a2 may be stacked on the first band set 211a1, the third band set 211a3 may be stacked on the second band set 211a2, the fourth band set 211a4 may be stacked on the third band set 211a3, and the fifth band set 211a5 may be stacked on the fourth band set 211a4. The first to fifth band sets 211a1, 211a2, 211a3, 211a4, and 211a5 may be connected to each other along the lengthwise direction “L.”

Areas of the first to fifth band sets 211a1, 211a2, 211a3, 211a4, and 211a5, which are connected to each other to contact each other, may be named a first band set part, a second band set part, a third band set part, a fourth band set part, and a fifth band set part, respectively.

The first to fifth band set parts may be oriented in the first to fifth directions, respectively. For example, the fibers “F” included in the first band set part may be oriented in the first direction, the fibers “F” included in the second band set part may be oriented in the second direction, the fibers “F” included in the third band set part may be oriented in the third direction, the fibers “F” included in the fourth band set part may be oriented in the fourth direction, and the fibers “F” included in the fifth second band set part may be oriented in the fifth direction.

Furthermore, an imaginary straight line that extends in the first direction may be defined as a first straight line L1, an imaginary straight line that extends in the second direction may be defined as a second straight line L2, an imaginary straight line that extends in the third direction may be defined as a third straight line L3, an imaginary straight line that extends in the fourth direction may be defined as a fourth straight line L4, and an imaginary straight line that extends in the fifth direction may be defined as a fifth straight line L5.

The second straight line L2 may be formed to be inclined by the stack angle “a” in the first circumferential direction C1 with respect to the first straight line L1. The third straight line L3 may be formed to be inclined by the stack angle “a” in the first circumferential direction C1 with respect to the second straight line L2. The fourth straight line L4 may be formed to be inclined by the stack angle “a” in the first circumferential direction C1 with respect to the third straight line L3. Furthermore, the fifth straight line L5 may be formed to be inclined by the stack angle “a” in the first circumferential direction C1 with respect to the fourth straight line L4. In other words, among the plurality of band sets 211, two band sets that are connected to each other in arbitrary two adjacent band sets may define the same stack angle “a.”

The plurality of band sets 211 may be disposed to surround a central portion of the dome part 120. Furthermore, each of the plurality of band sets 211 may have a shape that is rotationally symmetrical “n” (“n”>2) times with respect to the reference straight line CL. The band set 211 having a shape that is rotationally symmetrical “n” times with respect to the reference straight line CL may mean a shape that completely overlaps the band set 211 before rotation when the shape of the band set 211 is rotated 360 degrees/n with respect to the reference straight line CL.

For example, each of the plurality of band sets 211 may have a shape that is rotationally symmetrical four times with respect to the reference straight line CL. That is, a shape of the band set 211 may be a shape that completely overlaps the band set 211 before rotation when the band set 211 is rotated 90 degrees (360 degrees/4) with respect to the reference straight line CL.

When any partial area of the reference band set 211b is defined as a first reference band, an area of the first reference band that surrounds the cylinder part 110 is defined as a reference cylinder area, and any partial area of the stacked band set 211a is defined as a first stacked band, and when an area of the first stacked band that surrounds the cylinder part 110 is defined as a stacked cylinder area, the reference cylinder area and the stacked cylinder area may be arranged to contact each other along an adjacent direction that is a direction that is perpendicular to a direction in which the reference cylinder area and the stacked cylinder area extend. For example, one side of the reference cylinder area in the adjacent direction may contact an opposite side of the stacked cylinder area in the adjacent direction.

The first reference band may mean, among the plurality of reference bands 211b-1, one arbitrary reference band that defines one reference band set 211b. For example, as illustrated in FIG. 3, when the reference band set 211b has a shape that is rotationally symmetrical four times, one reference band set 211b may include four reference bands 211b-1, and the four reference bands 211b-1 may be named a first reference band, a second reference band, a third reference band, and a fourth reference band, respectively.

The first stacked band may be stacked on the first reference band in the dome part 120. The first stacked band may mean, among the plurality of stacked bands 211a-1 that define one stacked band set 211a, a stacked band that is stacked on the first reference band to cross a center of the first reference band.

For example, one stacked band set 211a may include four stacked bands 211a-1, and the four stacked bands 211a-1 may be named a first stacked band, a second stacked band, a third stacked band, and a fourth stacked band, respectively. Furthermore, the first stacked band may be disposed to cross a center of the first reference band, the second stacked band may be disposed to cross a center of the second reference band, the third stacked band may be disposed to cross a center of the third reference band, and the fourth stacked band may be disposed to cross a center of the fourth reference band. In other words, the plurality of stacked bands 211a-1 may be disposed to cross the centers of the plurality of reference bands 211b-1 so as to correspond to the plurality of reference bands 211b-1, respectively.

Furthermore, it has been described above that the numbers of the plurality of stacked bands 211a-1 and the plurality of reference bands 211b-1 are four, but this is only an example, and the numbers of the plurality of stacked bands 211a-1 and the plurality of reference bands may be “n” that is any one of natural values, such as 3 or 5 or more.

Furthermore, a size of a first winding angle that is an angle defined by a first cylinder direction that is a direction in which the reference cylinder area extends and the reference straight line CL, and a size of a second winding angle that is an angle defined by a second cylinder direction that is a direction in which the stacked cylinder area extends and the reference straight line CL may be the same.

Each of the plurality of band sets 211 may include a cross area and an extension area. The cross area may mean an area in which, among the plurality of bands, two different arbitrary bands cross each other. The cross area may be disposed on the dome part 120.

A plurality of cross areas may be provided. For example, four stacked bands 211a-1 that constitute one stacked band set 211a may define four cross areas 211a-11 (a first cross area, a second cross area, a third cross area, and a fourth cross area). As a more detailed example, the first stacked band and the second stacked band may define a first cross area, the second stacked band and the third stacked band may define a second cross area, the third stacked band and the fourth stacked band may define a third cross area, and the fourth stacked band and the first stacked band may define a fourth cross area. In other words, “n” stacked bands that constitute one stacked band set 211a may define “n” cross areas.

Furthermore, a size of a crossing angle “b” that is an angle defined by two different arbitrary bands that define the cross area, as an example, may be 50 degrees or less or 90 degrees. In a preferred example, a size of the crossing angle “b” may be 40 degrees or less or 90 degrees.

Furthermore, the sizes of the crossing angles defined by the plurality of cross areas, respectively, may be the same. For example, a first crossing angle defined by the first stacked band and the second stacked band, a second crossing angle defined by the second stacked band and the third stacked band, a third crossing angle defined by the third stacked band and the fourth stacked band, and a fourth crossing angle defined by the fourth stacked band and the first stacked band may be the same.

Furthermore, an area in which, among the two different arbitrary bands that define the cross areas in the plurality of bands, any one band surrounds the cylinder part 110, and an area in which another band surrounds the cylinder part may be spaced apart from each other with the cylinder part 110 being interposed therebetween. For example, two areas that surround the cylinder parts 110 of the first stacked band and the second stacked band that define the first cross area may be spaced apart from each other with the cylinder part 110 being interposed therebetween.

The plurality of cross areas may be rotationally symmetrical with respect to reference straight line CL. For example, when one side of the pressure vessel 10 in the lengthwise direction “L” is viewed in a direction that is parallel to the reference straight line CL, the plurality of cross areas may be rotationally symmetrical. The plurality of cross areas may be arranged to be spaced apart from each other along the circumferential directions C1 and C2 to surround a central portion of the dome part 120.

Furthermore, centers of, among the plurality of cross areas provided in each of the plurality of band sets 211, cross areas that are connected to each other to contact each other along the lengthwise direction “L” may be arranged in a spiral shape. The plurality of band sets 211 may include a first band set 211a1, a second band set 211a2, a third band set 211a3, and a fourth band set 211a4 that are sequentially stacked along the lengthwise direction “L.” Each of the first band set 211a1, the second band set 211a2, the third band set 211a3, and the fourth band set 211a4 may include a first cross area, a second cross area, a third cross area, and a fourth cross area that are connected to each other along the lengthwise direction “L.”

The second cross area may be stacked on the first cross area to contact the first cross area in the lengthwise direction “L.” The third cross area may be stacked on the second cross area to contact the second cross area in the lengthwise direction “L.” The fourth cross area may be stacked on the third cross area to contact the third cross area in the lengthwise direction “L.”

A center of the first cross area, a center of the second cross area, a center of the third cross area, and a center of the fourth cross area may be arranged in a spiral shape. Meanwhile, the description is only an illustrative description, and the plurality of band sets 211 may include five or more cross areas that are provided in five or more band sets, respectively, and are stacked to contact each other along the lengthwise direction “L,” and the centers of the five or more cross areas may be arranged in a spiral shape. Furthermore, a plurality of band sets 211 may include “n” (a natural number of 5 or more) or more cross areas that are provided in the band set of “n” (a natural number of 5 or more) or more, respectively, and are stacked to contact each other along the lengthwise direction “L,” and the centers of “n” (a natural number of 5 or more) or more cross areas can be arranged in a spiral shape.

The extension area may mean an area that extends between any two arbitrary adjacent cross areas. For example, the extension area may connect two adjacent cross areas with respect to the circumferential directions C1 and C2. The extension area may be disposed on the dome part 120.

A plurality of extension areas may be provided. For example, four stacked bands 211a-1 that constitute one stacked band set 211a may define four extension areas 211a-12. In other words, “n” stacked bands that constitute one stacked band set 211a may define “n” extension areas.

The plurality of extension areas may be rotationally symmetrical with respect to reference straight line CL. For example, when one side of the pressure vessel 10 in the lengthwise direction “L” is viewed in a direction that is parallel to the reference straight line CL, the plurality of extension areas may be rotationally symmetrical. The plurality of extension areas may be arranged to be spaced apart from each other along the circumferential directions C1 and C2 to surround a central portion of the dome part 120. In other words, the plurality of extension areas and the plurality of cross areas may be disposed alternately along the circumferential directions C1 and C2, respectively.

Furthermore, the plurality of extension areas may be defined by a plurality of different bands, respectively. For example, the four extension areas provided in one stacked band set 211a may be defined by the first stacked band, the second stacked band, the third stacked band, and the fourth stacked band, respectively.

The second composite material area 220 may mean an area that surrounds the cylinder part 110, excluding the third composite material area 230 from the composite material 200. The second composite material area 220 may connect the two first composite material areas 210. The second composite material area 220 may include a plurality of cylinder areas. The plurality of cylinder areas may include the reference cylinder area and the stacked cylinder area described above. Furthermore, a size of a winding angle that is an angle defined by the plurality of cylinder areas and the reference straight line CL may be the same. For example, when the pressure vessel 10 is viewed along a direction that is perpendicular to the lengthwise direction “L,” the size of the winding angle defined by the plurality of cylinder areas and the reference straight line CL may all be the same.

Furthermore, a thickness of the first composite material area 210 in the stack direction may be greater than a thickness of the second composite material area 220 in a radial direction. The radial direction may mean a radial direction of the cylinder part 110 and may be perpendicular to a direction in which the reference straight line CL extends. For example, the number of the band sets of the second composite material area 220 may be smaller than the number of the band sets of the first composite material area 210. As a detailed example, when the second composite material area 220 is formed with one band set, the first composite material area 210 may be formed with twelve band sets.

The first composite material area 210 may include a section of which a thickness in the stack direction increases as it goes from an area in which the dome part 120 and the cylinder part 110 are connected each other to a central portion of the dome part 120. In other words, the thickness of the first composite material area 210 in the stack direction may be formed such that a size of a portion of the first composite material area 210 at which the plurality of cross areas and the plurality of extension areas are formed is greater than sizes of the other portions.

Through the shape and disposition relationship of the first composite material area 210 and the second composite material area 220, a design may be made such that crack points of the pressure vessel 10, which are areas vulnerable to fatigue, are distributed in a predictable range. That is, when crack points occur in the pressure vessel 10, they may occur in a specific predictable area rather than sporadically.

Furthermore, a durability of the pressure vessel 10 increases, and an interaction between the plurality of bands enables uniform sharing of loads, and thus, an impact performance may be enhanced.

Furthermore, bending defects due to multiple band folds may be reduced, and thus, early breakage of the multiple fibers “F” may be prevented.

Furthermore, since stress is not concentrated in a local area of the pressure vessel 10, an amount of material inputs for stress relief may be minimized.

Furthermore, because the amount of material inputs into the pressure vessel 10 is minimized, a weight of the pressure vessel 10 is reduced, and thus, a fuel efficiency of the vehicle that uses the pressure vessel 10 may be increased.

The third composite material area 230 may include a plurality of bands that surround the cylinder part 110. An angle defined by the plurality of bands with the reference straight line CL may be greater than the winding angle. That is, the band-type base material that defines the third composite material area 230 may be stacked to be oriented substantially in parallel to the circumferential directions C1 and C2 of the cylinder part 110. It may be understood that the third composite material area 230 is a concept including a high-angle helically wound composite material and a low-angle helically wound composite material.

This third composite material area 230 may mean an area of the composite material 200 that contacts an outer surface of the cylinder part 110. For example, the third composite material area 230 may have a shape that only surrounds the cylinder part 110 and does not surround the dome part 120. In other words, the dome part 120 may be surrounded only by the first composite material area 210. The second composite material area 220 may be stacked on the third composite material area 230. For example, the cylinder part 110, the third composite material area 230, and the second composite material area 220 may be sequentially disposed outward in the radial direction. As a detailed example, after the third composite material area 230 is first wound on the outer surface of the cylinder part no by one band-type base material to be formed, the first composite material area 210 and the second composite material area 220 may be formed.

Referring back to FIG. 2, the nozzle 300 may be disposed on one side of the liner 100 in the lengthwise direction “L.” One end of the nozzle 300 in the lengthwise direction “L” may have a shape that protrudes from the liner 100 in the lengthwise direction “L.” In the nozzle 300, a nozzle space that communicates the interior space “S” with an outside of the pressure vessel 10 may be formed. In the nozzle space, a fluid that is introduced into the interior space “S” from the outside and a fluid that is discharged from the interior space “S” to the outside may flow.

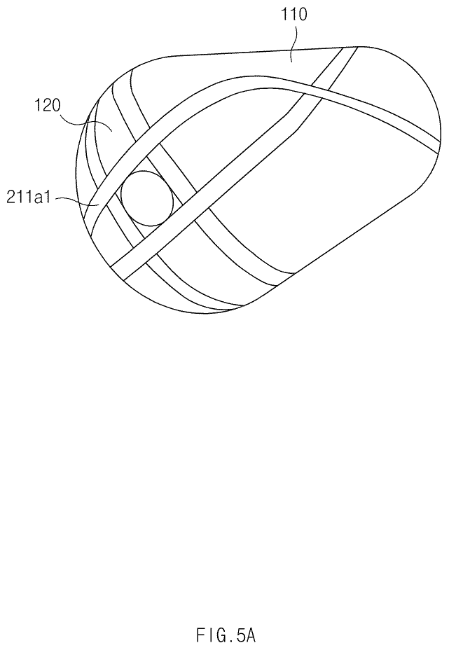

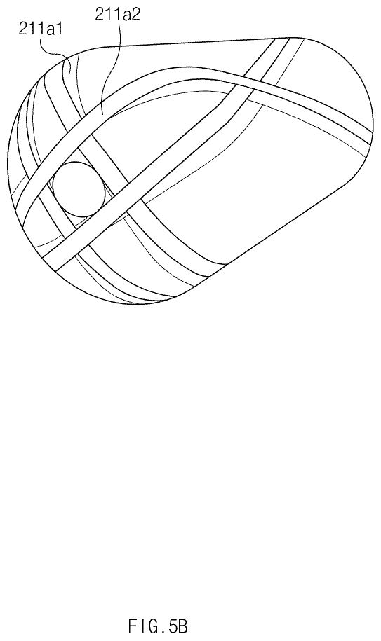

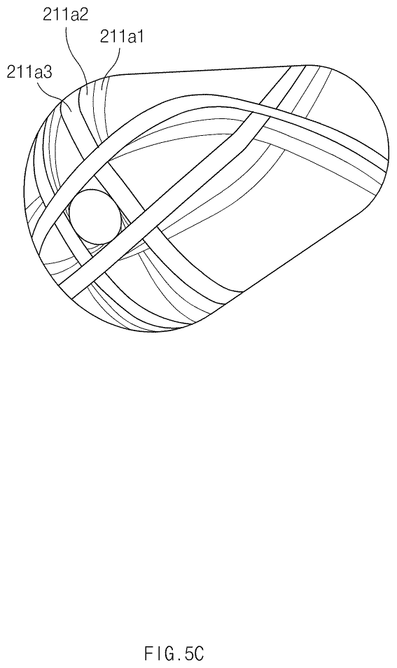

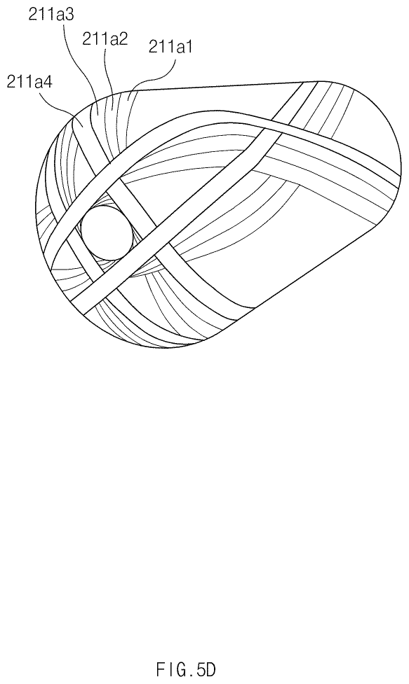

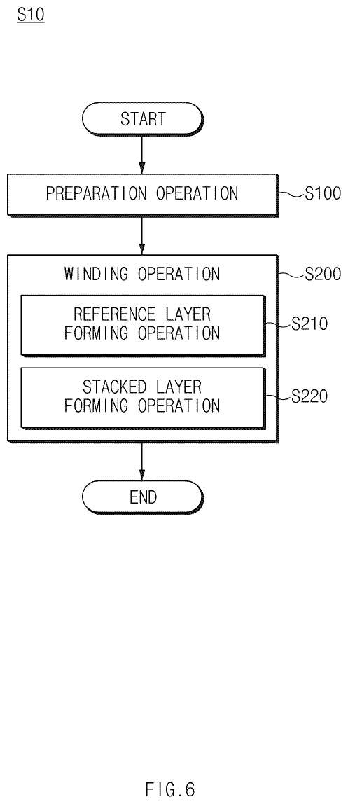

Hereinafter, a method S10 of manufacturing a pressure vessel according to an embodiment of the present disclosure will be described with reference to FIGS. 5A-5D and 6.

FIGS. 5A-5D are views sequentially illustrating states in which a plurality of band sets are stacked in a pressure vessel according to an embodiment of the present disclosure, and FIG. 6 is a flow chart schematically illustrating a method for manufacturing a pressure vessel according to an embodiment of the present disclosure.

The method S10 for manufacturing a pressure vessel may include a preparation operation S100 and a winding operation S200. In the preparation operation S100, the liner 100 may be prepared.

In the winding operation S200, a band-type base material may be wound on the outer surface of the liner 100. For example, after the band-type base material is wound to define a third composite material area 230 in the cylinder part 110 in the winding operation S200, a band-type base material may be wound such that the first composite material area 210 and the second composite material area 220 are formed in the liner 100. The winding operation S200 may include a reference band set forming operation S210 and a stacked band set forming operation S220.

In the reference band set forming operation S210, a band-type base material is wound on the outer surface of the dome part 120, so that the reference band set 211b may be formed in the dome part 120. In the reference band set forming operation S210, a plurality of reference bands 211b-1 may be formed sequentially along the first circumferential direction C1 or the second circumferential direction C2 on the dome part 120. For example, in the reference band set forming operation S210, the band-type base material may be wound on the liner 100 such that the first reference band, the second reference band, the third reference band, and the fourth reference band are sequentially formed on the dome part 120.

In the stacked band set forming operation S220, the band-type base material may be wound on the reference band set 211b so that a stacked band set may be formed in the dome part 120. In the stacked band set forming operation S220, a plurality of stacked bands 211a-1 may be formed sequentially along the first circumferential direction C1 or the second circumferential direction C2 on the dome part 120. For example, in the stacked band set forming operation S220, the band-type base material may be wound on the liner 100 such that the first stacked band, the second stacked band, the third stacked band, and the fourth stacked band are sequentially formed on the dome part 120.

Furthermore, in the stacked band set forming operation S220, the plurality of stacked bands 211a-1 may be formed to cross the centers of the plurality of reference bands 211b-1 on the dome part 120 to correspond to the plurality of reference bands 211b-1, respectively. For example, in the stacked band set forming operation S220, the first stacked band may be formed to cross the center of the first reference band, the second stacked band may be formed to cross the center of the second reference band, the third stacked band may be formed to cross the center of the third reference band, and the fourth stacked band may be formed to cross the center of the fourth reference band.

Furthermore, the stacked band set forming operation S220 may be performed repeatedly a plurality of times. An arbitrary one of the stacked band set forming operations S220 performed a plurality of times may be named a first operation, and a stacked band set forming operation S220 performed immediately after the first operation may be named the second operation.

A second stacked band set formed in the second operation may be formed on the first stacked band set formed in the first operation. Furthermore, the second stacked band set may have a shape that is rotated about the reference straight line in the first circumferential direction C1 by a stack angle with respect to the first stacked band set.

Hereinafter, referring back to FIGS. 4 and 5A-5D, a process of performing the reference band set forming operation S210 and the stacked band set forming operation S220 performed a plurality of times will be described in detail.

Referring to FIG. 5A, in the reference band set forming operation S210, a first band set 211ai may be formed on the outer surface of the dome part 120.

Referring to FIG. 5B, in the first stacked band set forming operation that is the stacked band set forming operation S220 performed immediately after the reference band set forming operation S210, a second band set 211a2 may be formed on the first band set 211ai. Then, it may be understood that the reference band set forming operation S210 and the first stacked band set forming operation correspond to the first operation and the second operation described above, respectively.

Referring to FIG. 5C, in the second stacked band set forming operation that is the stacked band set forming operation S220 performed immediately after the first stacked band set forming operation is performed, a third band set 211a3 may be formed on the second band set 211a2. Then, it may be understood that the first stacked band set forming operation and the second stacked band set forming operation correspond to the first operation and the second operation, which are the two arbitrary operations described above.

Referring to FIG. 5D, in the third stacked band set forming operation that is the stacked band set forming operation S220 performed immediately after the second stacked band set forming operation is performed, a fourth band set 211a4 may be formed on the third band set 211a3. Then, it may be understood that the second stacked band set forming operation and the third stacked band set forming operation correspond to the first operation and the second operation described above, respectively.

Furthermore, although not directly illustrated in the drawing, a plurality of stacked band set forming operations S220 may be further performed after the third stacked band set forming operation.

The pressure vessel according to embodiments of the present disclosure prevents cracks from occurring between adjacent bands due to an internal pressure load.

Furthermore, the pressure vessel according to embodiments of the present disclosure prevents permanent deformation in the pressure vessel due to folding of a portion of the band due to an internal pressure load.

In addition, the pressure vessel according to embodiments of the present disclosure has a high durability by which damage due to an external impact may be minimized.

In the above description, just because components constituting the embodiments of the present disclosure are described as being combined or operating in combination, embodiments of the present disclosure are not necessarily limited to these embodiments. That is, within the scope of the embodiments of the present disclosure, all of the components may operate in selective combination of one or more. In addition, terms such as “include,” “comprise,” or “have” described above mean that the corresponding component may be present, and thus do not exclude other components unless specifically stated to the contrary, and rather, it should be interpreted as being able to include other components. Unless defined differently, all the terms including technical or scientific terms have the same meanings as those generally understood by an ordinary person in the art to which the present disclosure pertains. The terms, such as the terms defined in dictionaries, which are generally used, should be construed to coincide with the context meanings of the related technologies and are not to be construed as having ideal or excessively formal meanings unless explicitly defined in the present disclosure.

The above description is a simple exemplary description of the technical spirits of embodiments of the present disclosure, and an ordinary person in the art to which the present disclosure pertains may make various corrections and modifications without departing from essential characteristics of embodiments of the present disclosure. Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

What is claimed is:

1. A pressure vessel comprising:
a liner configured such that a pressure is applied to an inner surface thereof, the liner comprising:
a cylinder part defining a central area of an outer surface of the liner; and
a dome part defining a peripheral area of the outer surface of the liner and connected to opposite ends of the cylinder part in a lengthwise direction, wherein when an imaginary straight line passing through a center of the liner and extending in the lengthwise direction is defined as a reference straight line; and
a composite material comprising:
a plurality of bands surrounding the outer surface of the liner; and
a first composite material area having a shape surrounding the dome part and in which a plurality of band sets, only portions of which overlap each other, are stacked along the lengthwise direction, wherein the first composite material area is rotationally symmetrical with respect to the reference straight line.

2. The pressure vessel of claim 1, wherein each of the plurality of band sets has a shape that surrounds a central portion of the dome part and is rotationally symmetrical with respect to the reference straight line.

3. The pressure vessel of claim 2, wherein the plurality of band sets have similar shapes.

4. The pressure vessel of claim 3, wherein:
the plurality of band sets are stacked in a stack direction; and
among two arbitrary band sets of the plurality of band sets that are adjacent to each other in the stack direction, a first band set located on a first side in the stack direction is a stacked band set and a second band set located on a second side in an opposite direction to the stack direction is a reference band set; and
the stacked band set overlaps the reference band set along the stack direction and has a shape that is rotated about the reference straight line and that is rotated in a first circumferential direction of the cylinder part by a stack angle with respect to the reference band set.

5. The pressure vessel of claim 4, wherein the stack angle is not less than 1 degree and not more than 30 degrees.

6. The pressure vessel of claim 4, wherein:
among the plurality of bands, a band defining any partial area of the reference band set is a reference band and a band defining any partial area of the stacked band set and stacked on the reference band in the dome part is a stacked band; and
an area of the reference band that surrounds the cylinder part and an area of the stacked band that surrounds the cylinder part are arranged to contact each other on one side in a direction perpendicular to a direction in which the reference band and the stacked band extend.

7. The pressure vessel of claim 1, wherein:
each of the plurality of bands comprises a plurality of cylinder areas surrounding the cylinder part; and
sizes of angles defined by the plurality of cylinder areas and the reference straight line are the same.

8. The pressure vessel of claim 1, wherein the composite material further comprises a second composite material area surrounding the cylinder part.

9. The pressure vessel of claim 8, wherein:
the plurality of band sets are stacked in a stack direction; and
a thickness of the first composite material area in the stack direction is greater than a thickness of the cylinder part of the second composite material area in a radial direction.

10. The pressure vessel of claim 9, wherein the thickness of the first composite material area in the stack direction is greater as it extends from an area in which the dome part and the cylinder part are connected to each other to a central portion of the dome part.

11. A pressure vessel comprising:
a liner configured such that a pressure is applied to an inner surface thereof, the liner comprising:
a cylinder part defining a central area of an outer surface of the liner; and
a dome part defining a peripheral area of the outer surface of the liner and connected to opposite ends of the cylinder part in a lengthwise direction, wherein when an imaginary straight line passing through a center of the liner and extending in the lengthwise direction is defined as a reference straight line; and
a composite material comprising:
a plurality of bands surrounding the outer surface of the liner; and
a first composite material area having a shape surrounding the dome part and in which a plurality of band sets, only portions of which overlap each other, are stacked along the lengthwise direction, wherein each of the plurality of band sets comprises a cross area at which two different arbitrary bands among the plurality of bands cross each other, wherein the cross area is disposed on the dome part, and wherein the first composite material area is rotationally symmetrical with respect to the reference straight line.

12. The pressure vessel of claim 11, wherein a size of an angle defined by the two different arbitrary bands is not less than 50 degrees and not more than 90 degrees.

13. The pressure vessel of claim 11, wherein an area in which a first band of the two different arbitrary bands surrounds the cylinder part and an area in which a second band of the two different arbitrary bands surrounds the cylinder part are spaced apart from each other with the cylinder part being interposed therebetween.

14. The pressure vessel of claim 11, further comprising a plurality of cross areas, wherein each of the plurality of cross areas is rotationally symmetrical with respect to the reference straight line.

15. The pressure vessel of claim 14, wherein:
each of the plurality of band sets further comprises a plurality of extension areas extending between two adjacent arbitrary cross areas from among the plurality of cross areas and alternately arranged with the plurality of cross areas along a circumferential direction of the cylinder part; and
the plurality of extension areas are defined by the plurality of different bands.

16. The pressure vessel of claim 14, wherein, among the plurality of cross areas, the cross areas connected to contact each other along the lengthwise direction are arranged on a spiral shape.

17. A method for manufacturing a pressure vessel, the method comprising:
a preparation operation of preparing a liner, the liner being configured such that a pressure is applied to an inner surface thereof; and
a winding operation of winding a band-type base material on an outer surface of the liner, wherein the winding operation comprises:
a reference band set forming operation of forming a reference band set in a dome part of the liner by winding the band-type base material on the outer surface of the liner, wherein a plurality of reference bands corresponding to first partial areas of the wound band-type base material are sequentially formed on the dome part along a circumferential direction of a cylinder part; and
a stacked band set forming operation of forming a stacked band set in the dome part by winding the band-type base material on the reference band set, wherein a plurality of stacked bands corresponding to second partial areas of the wound band-type base material are sequentially formed in the dome part along the circumferential direction, and wherein the stacked band set forming operation comprises forming the plurality of stacked bands such that the plurality of stacked bands cross centers of the plurality of reference bands on the dome part to correspond to the plurality of reference bands, respectively.

18. The method of claim 17, wherein:
a first band of the plurality of reference bands is a first reference band; and
a first stacked band of the plurality of stacked bands corresponds to the first reference band and crosses the first reference band.

19. The method of claim 18, wherein:
the stacked band set forming operation comprises forming the stacked band set such that the first reference band and the first stacked band define a stack angle;
the stacked band set forming operation is repeatedly performed a plurality of times;
a first operation is an arbitrary operation from among the stacked band set forming operations performed the plurality of times and a second operation is an operation from among the stacked band set forming operations performed immediately after the first operation is performed;
a second stacked band set formed in the second operation is stacked on the first stacked band set formed in the first operation; and
the second stacked band set has a shape overlapping the first stacked band set along a stack direction and being rotated about a reference straight line in a first circumferential direction by the stack angle with respect to the first stacked band set.
